(19) United States
(12) Patent Application Publication
(10) Pub. No.: US 2016/0012393 A1
(43) Pub. Date: Jan. 14, 2016

(54) PARCEL DELIVERY METHOD USING AN UNMANNED AERIAL VEHICLE

(71) Applicant: NUTEX COMMUNICATIONS CORP., Baoshan Township (TW)

(72) Inventors: Guan-Wu WANG, Los Altos Hills, CA (US); Yi-Hung CHEN, Hsinchu City (TW); Yi-Jeng WANG, Los Altos Hills, CA (US); Wen-Chung LIU, Hsinchu City (TW)

(21) Appl. No.: 14/665,739

(22) Filed: Mar. 23, 2015

Related U.S. Application Data
(60) Provisional application No. 61/998,966, filed on Jul. 14, 2014.

(51) Int. Cl. G06Q 10/08

(52) U.S. Cl. CPC G06Q 10/08355

(57) ABSTRACT

In a parcel delivery method and system, a server continuously receives recipient geographic position information (GPI) from a recipient terminal associated with and carried by a recipient, and unmanned aerial vehicle (UAV) GPI from a UAV loaded with a to-be-delivered parcel via a communication network, and transmits, to the UAV, destination information, which is the recipient GPI that is last received by the server. The UAV transports, based on the destination information from the server, the parcel to an unloading position where the recipient terminal is located.

### CROSS-REFERENCE TO RELATED APPLICATION

This application claims priority to U.S. Patent Provisional Application No. 61/998,966, filed on Jul. 14, 2014, the contents of which are hereby incorporated by reference.

### FIELD

The disclosure relates to parcel delivery, and more particularly to a parcel delivery method using an unmanned aerial vehicle (UAV).

### BACKGROUND

A conventional UAV is typically manually controlled by an operator who may observe the viewpoint of the UAV during flight with reference to images provided by cameras installed on the UAV through downlink telemetry. With technological advancement, recently, UAVs capable of autonomous navigation have been developed to deliver goods to places where road transport infrastructure is not developed or is underdeveloped.

### SUMMARY

Therefore, an object of the present disclosure is to provide a parcel delivery method using an unmanned aerial vehicle (UAV) that can automatically deliver one or more parcels among a plurality of user terminals carried respectively by clients in a social network.

According to one aspect of the present disclosure, there is provided a parcel delivery method to be implemented by a parcel delivery system. The parcel delivery system includes a server, an unmanned aerial vehicle (UAV) and a recipient terminal that are connected to a communication network. The recipient terminal is associated with and carried by a recipient. The parcel delivery method of this disclosure includes the steps of:

a) by the server, continuously receiving recipient geographic position information from the recipient terminal and UAV geographic position information from the UAV via the communication network;

b) after receipt of a delivery request for a parcel, which has been previously loaded on the UAV and is to be delivered to the recipient, via the communication network, by the server, transmitting the recipient geographic position information, which is last received by the server and which serves as destination information, to the UAV via the communication network; and

c) after receipt of the destination information from the server, by the UAV, transporting, based at least on the destination information, the parcel to an unloading position where the recipient terminal is located.

According to another aspect of the present disclosure, there is provided a parcel delivery method to be implemented by a parcel delivery system. The parcel delivery system includes a sender terminal, a server, an unmanned aerial vehicle (UAV) and a recipient terminal that are connected to a communication network, the sender terminal being associated with and carried by a sender. The recipient terminal is associated with and carried by a recipient. The parcel delivery method of this disclosure includes the steps of:

a) by the server, continuously receiving recipient geographic position information from the recipient terminal and UAV geographic position information from the UAV via the communication network;

b) after receiving from the sender terminal a delivery request for a parcel, which has been previously loaded on the UAV and is to be delivered to the recipient, via the communication network, by the server, transmitting a delivery flight path, which has been previously determined based on the recipient geographic position information and the UAV geographic position information that are last received by the server and that cooperatively serve as destination information, to the UAV via the communication network; and

c) after receipt of the delivery flight path from the server, by the UAV, transporting, based the delivery flight path, the parcel to an unloading position where the recipient terminal is located.

According to still another aspect of the present disclosure, a parcel delivery system includes:

a server connected to a communication network;

an unmanned aerial vehicle (UAV) connected to the communication network, the UAV being configured to continuously generate UAV geographic position information thereof and transmit the UAV geographic position information generated thereby to the server via the communication network; and

a recipient terminal associated with and carried by a recipient, and connected to the communication network, the recipient terminal being installed with an application associated with parcel delivery, continuously generating recipient geographic position information thereof, and transmitting, through execution of the application, the recipient geographic position information generated thereby to the server terminal via the communication network.

After a parcel, which is to be delivered to the recipient, has been loaded on the UAV, the parcel delivery system is operable to perform a parcel-delivering procedure of a parcel delivery method, in the parcel-delivering procedure,

after receipt of a delivery request for the parcel via the communication network, the server transmits, the recipient geographic position information, which is last received by the server and which serves as destination information, to the UAV via the communication network, and

after receipt of the destination information from the server, the UAV transports, based at least on the destination information, the parcel to an unloading position where the recipient terminal is located.

According to a further aspect of the present disclosure, a parcel delivery system includes:

a sender terminal associated with and carried by a sender, and connected to a communication network, the sender terminal being installed with an application associated with parcel delivery;

a server terminal connected to the communication network;

an unmanned aerial vehicle (UAV) connected to the communication network, the UAV being configured to continuously generate UAV geographic position information thereof and transmit the UAV geographic position information generated thereby to the server via the communication network; and

a recipient terminal associated with and carried by a recipient, and connected to the communication network, the recipient terminal being installed with the application, continuously generating recipient geographic position information thereof, and transmitting, through execution of the application, the recipient geographic position information generated thereby to the server terminal via the communication network.

After loading of a parcel, which is to be delivered to the recipient, on the UAV, the parcel delivery system is operable to perform a parcel-delivering procedure of a parcel delivery method, in the parcel-delivering procedure,

after receiving from the sender terminal a delivery request for the parcel via the communication network, the server transmits a delivery flight path, which has been previously determined based on the recipient geographic position information and the UAV geographic position information that are last received by the server terminal and that cooperatively serve as destination information, to the UAV via the communication network, and

after receipt of the delivery flight path from the server terminal, the UAV transports, based the delivery flight path, the parcel to an unloading position where the recipient terminal is located.

### BRIEF DESCRIPTION OF THE DRAWINGS

Other features and advantages of the present disclosure will become apparent in the following detailed description of the embodiment with reference to the accompanying drawings, of which:

FIG. 1 is a schematic view illustrating a parcel delivery system according to the embodiment of the present disclosure;

FIG. 2 is a schematic block diagram illustrating a UAV of the parcel delivery system;

FIG. 3 illustrates a parcel-loading procedure of a parcel delivery method according the embodiment of the present disclosure; and

FIG. 4 illustrates a parcel-delivering procedure of the parcel delivery method;

FIG. 5 illustrates a first variation of the parcel-delivering procedure of the parcel delivery method according to the embodiment; and

FIG. 6 illustrates a second variation of the parcel-delivering procedure of the parcel delivery method according to the embodiment.

### DETAILED DESCRIPTION

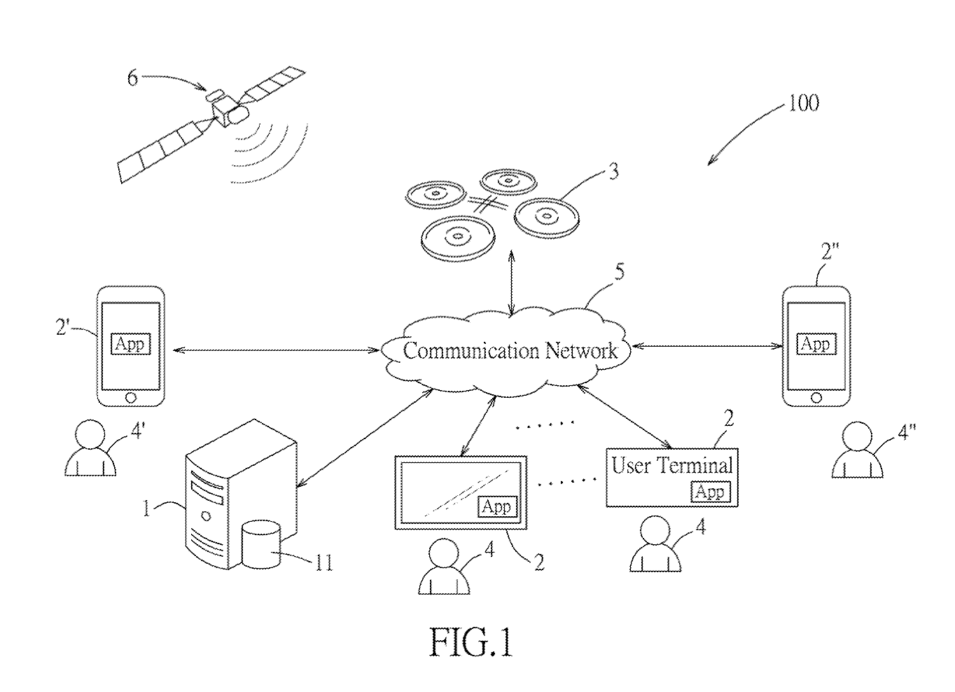

Referring to FIG. 1, a parcel delivery system 100 according to the embodiment of this disclosure is shown to include a server 1, an unmanned aerial vehicle (UAV) 3 and a plurality of user terminals 2, 2′, 2″ that are connected to a mobile communication network 5, such as a cellular network using the 4G LTE technologies.

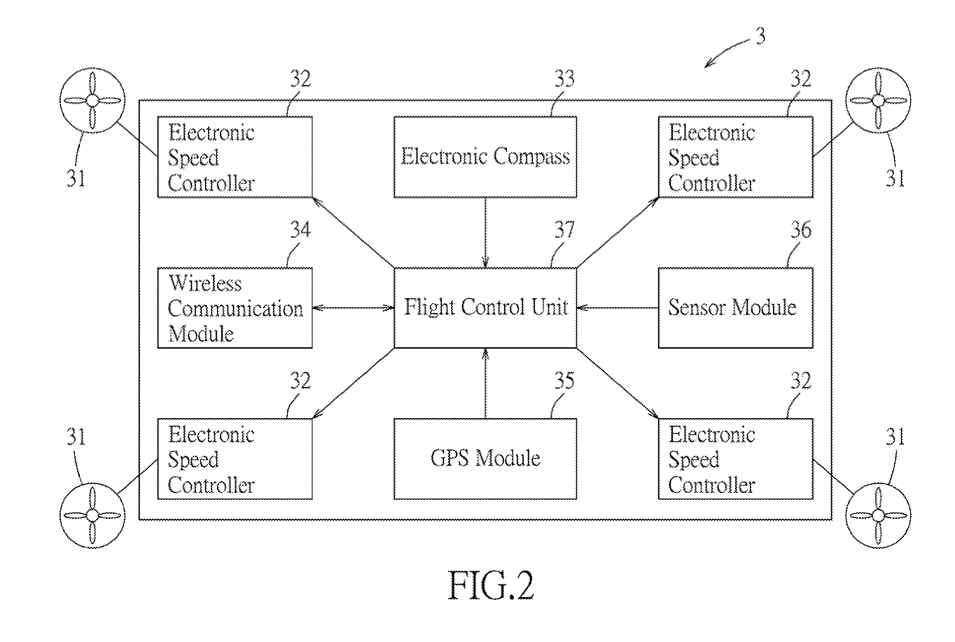

The UAV 3 can automatically fly between any two geographic locations. The UAV 3 can use, for example, global positioning system (GPS) for location tracking and navigation. The UAV 3 may be rotorcraft, fixed wing, or hybrid. In certain embodiment, the UAV 3 has vertical take-off and landing capability. Referring further to FIG. 2, an exemplary embodiment of the UAV 3 includes, but is not limited to, four propeller modules 31, four electronic speed controllers 32, an electronic compass 33, a wireless communication module 34, a GPS module 35, a sensor module 36 and a flight control unit 37.

Each electronic speed controller 32 is configured to control a respective propeller module 31 based on a control signal from the flight control unit 37. The electronic compass 33 is configured to provide orientation data to the flight control unit 37. The wireless communication module 34 is connected to the communication network 5 of FIG. 1 for communicate with the server 1. The GPS module 35 is configured to receive GPS data from a GPS satellite 6, to generate, based on the GPS data received thereby, UAV geographic position information corresponding to a current position of the UAV 3, and to provide the UAV geographic position information to the flight control unit 37. The sensor module 36 may include various sensors (not shown), for example, an inertial measurement unit, an accelerometer, a gyroscope, a gravity sensor, a pressure sensor, an altimeter, an ultrasound sensor for anti-collision, etc., that are used for navigation during take-off and during flight and to assist in landing, and that provide sensing result to the flight control unit 37. The flight control unit 37 can determine a flight path to a desired destination position based on destination information received thereby from the wireless communication module 34 and associated with the desired destination position, and on one or more environment maps that covers the current position of the UAV 3 and the desired destination position. It is noted that the environment map(s) may be pre-stored in the flight control unit 37 or may be received by the wireless communication module 34 through the communication network 5. For example, through execution of certain flight control programs pre-installed in the flight control unit 37, the flight control unit 37 generates the control signals based on the sensing result from the sensor module 36, the UAV geographic position information from the GPS module 35, and the orientation data from the electronic compass 33, such that the electronic speed controllers 32 control respectively the propeller modules 31 in response to the control signals to enable the UAV 3 to automatically fly along the flight path. Further, the flight control unit 37 continuously transmits the UAV geographic position information received from the GPS module 35 to the server 1 through the wireless communication module 34 via the communication network 5. Since the feature of this disclosure does not reside in the configuration of the UAV 3, which is known to those skilled in the art, further details of the same are omitted herein for the sake of brevity.

Referring again to FIG. 1, each user terminal 2, 2′, 2″ can receive GPS data from the GPS satellite 6. Each user terminal 2, 2′, 2″ may be a mobile device, such as a smart phone, a tablet computer, a notebook computer or the like.

In this embodiment, each user terminal 2, 2′, 2″ is installed with an application associated with parcel delivery. It is noted that the user terminals 2, 2′, 2″ are associated with and carried by respective users 4, 4′, 4″ who may be, for example, clients in a certain social network (e.g., Facebook, Yahoo, etc.). Therefore, in the social network, any one of the clients/users may act as a sender for one or more parcels to be delivered, and at least one of the remaining clients/users may act as a recipient.

In use, upon execution of a pre installed application, which is generally also referred to as an “app” and which is provided by, for example, the server 1, each of the user terminals 2, 2′, 2″ generates, based on the GPA data received thereby, user geographic position information corresponding to a current position thereof, and continuously transmits the individual user geographic position information to the server 1 at a certain rate via the communication network 5. In addition, each of the user terminals 2, 2′, 2″ further generates, through execution of the app, a user input interface (not shown) that is displayed thereon and that provides a recipient list containing one or more desired recipients.

The server 1 includes a group database 1I associated with the users 4, 4′, 4″ and storing relationship between each of the users 4, 4′, 4″ and an associated one of the user terminals 2, 2′, 2″.

In actual use, other people may be invited by any one of the users 4, 4′, 4″ to download the application, using a user terminal thereof, from the server 1, and is thus registered in the group database 11 to become an added user. A copy of the updated group database 11 may be transmitted to and stored in each of the user terminals 2, 2′, 2″. By using the user terminal 2, 2′, 2″ executing the application, each of the users 4, 4′, 4″ may pick from the group database 11 to form the recipient list for parcel delivery.

The parcel delivery system 100 can be used to implement a parcel delivery method according to the embodiment of the disclosure. The parcel delivery method according to the embodiment includes a parcel-loading procedure and a parcel-delivering procedure.

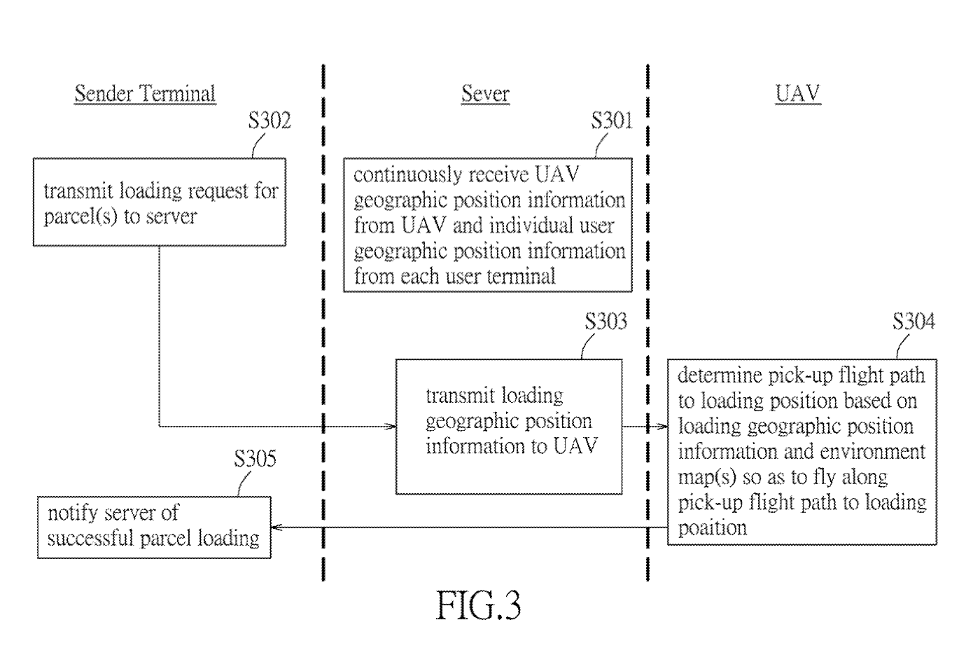

Referring to FIGS. 1 to 3, the parcel-loading procedure of the parcel delivery method according to the embodiment is shown to illustrate how one or more parcels to be delivered are loaded on the UAV 3, and includes the following steps.

In step S301, the server 1 continuously receives the UAV geographic position information from the UAV 3 and the individual user geographic position information from each user terminal 2, 2′, 2″ via the communication network 5.

In step S302, one of the user terminals 2, 2′, 2″, for example, the user terminal 2′ (hereinafter referred as a sender terminal) carried by the respective one of the users, 4, 4′, 4″(hereinafter referred as a sender 4′) transmits a loading request for the parcel(s) to the server 1 via the communication network 5 by executing the application. In this embodiment, the loading request includes loading geographic position information that corresponds to a loading position where the parcel(s) is/are to be loaded. In the case that the parcel(s) is/are provided by the sender (i.e., the user 4′ who carries the sender terminal 2′), the loading position is the position of the sender terminal 2′ (i.e., a position of the sender 4′). In this case, ideally, there is a floor surface suitable for landing of the UAV 3 at the loading position. Alternatively, the loading position may be different from the position of the sender terminal 2′.

In step S303, upon receipt of the loading request from the sender terminal 2′, the server 1 transmits the loading geographic position information (serving as the destination information) to the UAV 3 via the communication network 5.

In step S304, after receipt of the loading geographic position information from the server 1 by the wireless communication module 43, the flight control unit 37 of the UAV 3 determines, based on the loading geographic position information and one or more environment maps (not shown) that cover a current position of the UAV 3 and the loading position, a pick-up flight path to the loading position so as to fly along the pick-up flight path to the loading position. In this embodiment, for example, the environment map(s) may be pre-stored in the flight control unit 37. Alternatively, the server 1 may pre-store the environment map(s) and transmits the same to the UAV 3 via the communication network 5. After arrival of the UAV 3 at the loading position, the parcel(s) to be delivered can thus be loaded on the UAV 3.

In step S305, after the parcel(s) has/have been loaded on the UAV 3, the sender terminal 2′ notifies the server 1 of successful parcel loading, for example, through execution of the application.

Referring to FIGS. 1, 2 and 4, the parcel-delivering procedure of the parcel delivery method is shown to illustrate how the parcel(s) loaded on the UAV 3 is/are delivered, and includes the following steps.

In step S401, the sender terminal 2′ transmits, through execution of the application, a delivery request for the parcel(s) to the server 1 via the communication network 5. In this embodiment, the delivery request includes recipient data, for example, which may include the recipient list that has been set by the sender 4′ through input operation of the user input interface and that records the recipient(s) for orderly delivery. As one example, when a single parcel loaded on the UAV 3 is to be delivered to a single recipient, e.g., the user 4″, the recipient list merely shows the single recipient 4″. As another example, when a plurality of parcels loaded on the UAV 3 are to be delivered respectively to a plurality of recipients, e.g., the users 4″ (only one is shown in FIG. 1), the recipient list will show the users 4″. Thereinafter, the user terminal (s) 2″(only one is shown in FIG. 1) associated with the recipient(s) 4″ is/are regarded as the recipient terminal(s), and the user geographic position information transmitted by each recipient terminal 4″ is regarded as recipient geographic position information.

In step S402, after receipt of the delivery request from the sender terminal 2′, the server 1 transmits, based on the delivery request and the group database 11, the recipient geographic position information, which is last received from each recipient terminal 2″ by the server 1, to the UAV 3 via the communication network 5. In the example of the single recipient 4″, the last received recipient geographic position information serves as the destination information. In the example of the multiple recipients 4″, plural sets of the last received recipient geographic position information respectively from the recipient terminals 2″, and a priority delivery order cooperatively constitute the destination information. It is noted that, for example, the priority delivery order corresponds to the order of the recipients 4″recorded in the recipient list. Alternatively, the priority delivery order may be determined by the server 1 based on, for example, the relationship among the sets of the last received recipient geographic position information and the UAV geographic position information.

In step S403, after receipt of the destination information from the server 1 by the wireless communication module 34, the flight control unit 37 of the UAV 3 determines a delivery flight path based on the destination information and one or more environment maps that cover the current position of the UAV 3 and a respective unloading position for each parcel.

Following step S402, in step S404, the server 1 further detects, based on the destination information and on the recipient geographic position information from each recipient terminal 2″received thereby after transmitting the destination information to the UAV 3, whether the position of each recipient terminal 2″ has changed so as to generate a detection result, and transmits the detection result to the UAV 3 via the communication network 5. It is noted that, when the server 1 detects that the position of any recipient terminal 2″ has changed, the detection result includes updated destination information corresponding to the position of the recipient terminal 2″ that has changed.

In step S405, the UAV 3 transports, based on the delivery flight path generated in step S403 and the detection result from the server 1, each parcel to the respective unloading position where a respective recipient terminal 2″ is located. In this embodiment, the detection result may be used by the UAV 3 to determine whether the delivery flight path determined in step S403 requires updating or not. For example, when the server 1 detects that the position of any recipient terminal 2″ has changed, the UAV 3 updates the delivery flight path based on the updated destination information included in the detection result, and transports each parcel to the respective unloading position along the delivery flight path thus updated. It is noted that, in the example of the multiple recipients 4″, the delivery flight path is configured to pass through the unloading positions in the priority delivery order.

On the other hand, for example, when the detection result indicates that the position of each recipient terminal 2″ has not changed, the UAV 3 determines to keep the original delivery flight path generated in step S403, such that, in step S405, the UAV 3 flies along the original delivery flight path to transport each parcel to the respective unloading position.

In this embodiment, ideally, there is a floor surface suitable for landing of the UAV 3 at each unloading position.

In the case of the single recipient 4″, the UAV 3 notifies the server 1 of delivery completion via the communication network 5 upon arrival at the unloading position, i.e., the final unloading position (S406). After unloading of the parcel from the UAV 3 by, for example, the recipient 4″, the recipient 4″ may operate the recipient terminal 2″ to notify the server 1 of reception confirmation using the user input interface via the communication network 5 (step S407).

In the case of the multiple recipients 4″, whenever the UAV 3 arrives at one intermediate unloading position in the delivery flight path, the UAV 3 may stay at the intermediate unloading position for a time period enough to unload a relevant one of the parcels, and then flies again along the delivery flight path to a next one of the unloading positions until the UAV 3 arrives at the final unloading position. Upon arrival at the final unloading position, the UAV 3 notifies the server 1 of delivery completion via the communication network 5 (step S406). For each recipient terminal 2″, after unloading of the relevant one of the parcels from the UAV 3 by, for example, the relevant recipient 4″, the relevant recipient 4″ may operate the recipient terminal 2″ to notify the server 1 of reception confirmation using the user input interface via the communication network 5 (step S407).

Following steps S406 and S407, upon receipt of the notification of delivery completion from the UAV 3 and of the notification(s) of reception confirmation from the recipient terminal(s) 2″, the server notifies the sender terminal 2′ of successful delivery via the communication network 5.

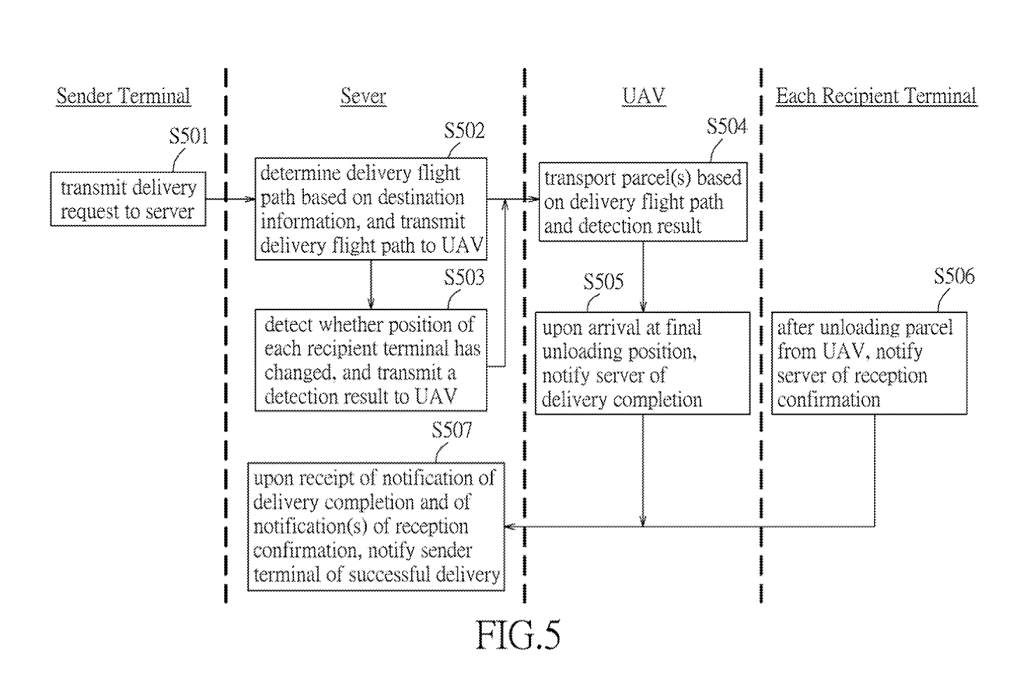

Referring to FIGS. 1, 2 and 5, a first variation of the parcel-delivering procedure of the parcel delivery method is shown to include the following steps.

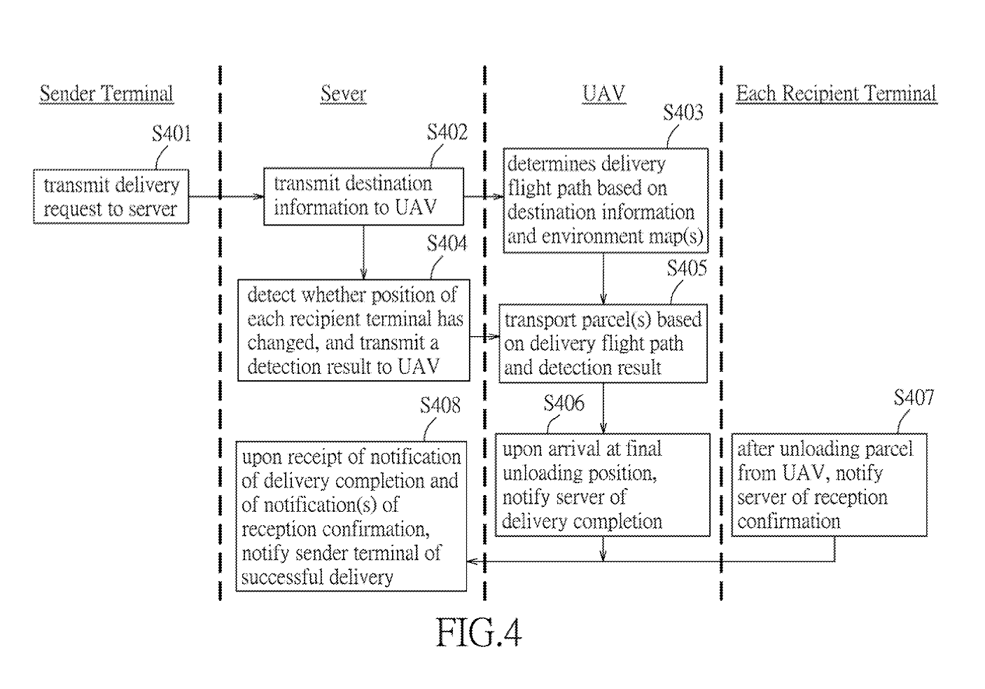

In step S501, similar to step S401 of FIG. 4, the sender terminal 2′ transmits, through execution of the application, the delivery request for the parcel (s) to the server terminal 1 via the communication network 5.

In step S502, after receipt of the delivery request from the sender terminal 2′, the server 1 determines a delivery flight path based on the recipient geographic position information and the UAV geographic position information that are last received by the server 1, and then transmits the delivery flight path determined thereby to the UAV 3 via the communication network 5.

In step S503, similar to step S404 of FIG. 4, the server 1 further detects, based on the destination information and on the recipient geographic position information from each recipient terminal 2″received thereby after the transmission of the destination information, whether the position of each recipient terminal 2″ has changed so as to generate a detection result, and transmits the detection result to the UAV 3 via the communication network 5. It is noted that, when the server 1 detects that the position of any recipient terminal 2″ has changed, the detection result includes updated destination information corresponding to the position of the recipient terminal 2″ that has changed.

Following steps S502 and S503, in step S504, similar to step S405 of FIG. 4, the UAV 3 transports, based on the delivery flight path generated in step S403 and the detection result from the server terminal 1, each parcel to a respective unloading position where a respective recipient terminal 2″ is located. In this embodiment, the detection result may be used to determine whether the delivery flight path determined in step S503 requires updating or not. For example, when the server 1 detects that the position of any recipient terminal 2″ has changed, the UAV 3 updates the delivery flight path based on the updated destination information included in the detection result, and transports each parcel to the respective unloading position along the delivery flight path updated thereby.

Operations of steps S505, S506 and S507 are similar respectively to those of steps S406, S407 and S408 of FIG. 4.

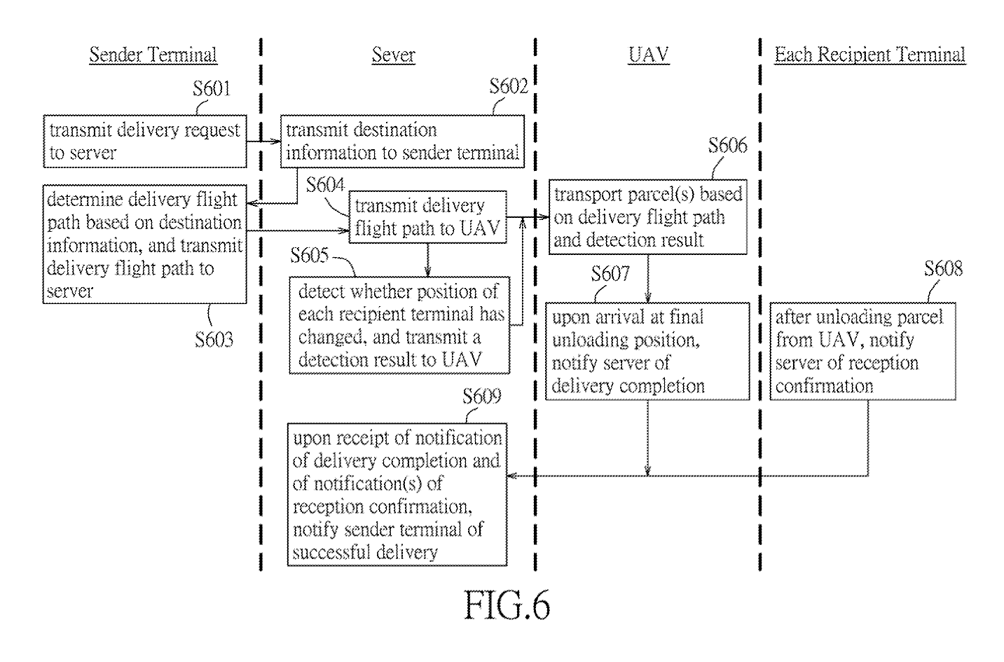

Referring to FIGS. 1, 2 and 6, a second variation of the parcel-delivering procedure of the parcel delivery method is shown to include the following steps.

In step S601, similar to step S401 of FIG. 4, the sender terminal 2′ transmits, through execution of the application, the delivery request for the parcel(s) to the server 1 via the communication network 5.

In step S602, after receipt of the delivery request from the sender terminal 2′, the server 1 transmits the recipient geographic position information and the UAV geographic position information that are last received and that cooperatively serve as the destination information in this embodiment to the sender terminal 2′ via the communication network 5.

In step S603, upon receipt of the destination information from the server 1, the sender terminal 2′ determines, through execution of the application, a delivery flight path based on the destination information received thereby, and then transmits the delivery flight path determined thereby to the server 1 via the communication network 5.

In step S604, upon receipt of the delivery flight path from the sender terminal 2′, the server 1 transmits the delivery flight path to the UAV 3 via the communication network 5.

In step S605, similar to step S404 of FIG. 4, the server 1 further detects, based on the destination geographic position information and on the recipient geographic position information from each recipient terminal 2″received thereby after the transmission of the destination information, whether the position of each recipient terminal 2″ has changed so as to generate a detection result, and transmits the detection result to the UAV 3 via the communication network 5. It is noted that, when the server 1 detects that the position of any recipient terminal 2″ has changed, the detection result includes updated destination information corresponding to the position of the recipient terminal 2″ that has changed.

Following steps S604 and S605, in step S606, similar to step S405 of FIG. 4, the UAV 3 transports, based on the delivery flight path and the detection result from the server 1, each parcel to a respective unloading position where a respective recipient terminal 2″ is located. In this embodiment, the detection result may be used to determine whether the delivery flight path determined in step S603 requires updating or not. For example, when the server 1 detects that the position of any recipient terminal 2″ has changed, the UAV 3 updates the delivery flight path based on the updated destination information included in the detection result, and transports each parcel to the respective unloading position along the delivery flight path updated thereby.

Operations of steps S607, S608 and S609 are similar respectively to those of steps S406, S407 and S408 of FIG. 4.

To sum up, the parcel delivery system 100 of this disclosure can implement the parcel delivery method of this disclosure to achieve automatic parcel delivery among the users 4, 4′, 4″ of a specific group, such as family members, friends and coworkers, using the UAV 3, the server terminal 1, and the user terminals 2, 2′, 2″installed with the application and carried by the users 4, 4′, 4″.

While the present disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A parcel delivery method to be implemented by a parcel delivery system, the parcel delivery system including a server, an unmanned aerial vehicle (UAV) and a recipient terminal that are connected to a communication network, the recipient terminal being associated with and carried by a recipient, said parcel delivery method comprising the steps of:
a) continuously receiving, by the server, recipient geographic position information from the recipient terminal and UAV geographic position information from the UAV via the communication network;
b) after receiving via the communication network a delivery request for a parcel, which has been previously loaded on the UAV and is to be delivered to the recipient, transmitting, by the server, the recipient geographic position information, which is last received by the server and which serves as destination information, to the UAV via the communication network; and
c) after receiving the destination information from the server, transporting, by the UAV based at least on the destination information, the parcel to an unloading position where the recipient terminal is located.

2. The parcel delivery method as claimed in claim 1, wherein step c) further includes the sub-steps of:
c1) in response to receipt of the destination information from the server, determining, by the UAV, a delivery flight path to the unloading position based at least on the destination information; and
c2) transporting, by the UAV, the parcel to the unloading position based at least on the delivery flight path.

3. The parcel delivery method as claimed in claim 2, wherein, in sub-step c1), the UAV determines the delivery flight path based on the destination information and further on an environment map that covers the current position of the UAV and the unloading position.

4. The parcel delivery method as claimed in claim 2, further comprising, subsequent to step b), the step of:
d) by the server, detecting, based on the destination information and on the recipient geographic position information received thereby after the transmission of the destination information, whether the position of the recipient terminal has changed so as to generate a detection result, and transmitting the detection result to the UAV via the communication network;
wherein, in sub-step c2), the UAV transports the parcel to the unloading position based on the delivery flight path and further on the detection result from the server terminal.

5. The parcel delivery method as claimed in claim 4, wherein:
in step d), when the server detects that the position of the recipient terminal has changed, the detection result includes updated destination information corresponding to the position of the recipient terminal that has changed; and
in step c2), the UAV updates the delivery flight path based on the updated destination information, and transports the parcel to the unloading position along the delivery flight path updated thereby.

6. The parcel delivery method as claimed in claim 1, the parcel delivery system further including a sender terminal connected to the communication network, and associated with and carried by a sender, said parcel delivery method further comprising, subsequent to step c), the steps of:
f) upon arrival at the unloading position, notifying the server, by the UAV, of delivery completion via the communication network;
g) after unloading of the parcel from the UAV, notifying the server, by the recipient terminal, of reception confirmation via the communication network; and
h) after receipt of the notifications of delivery completion and reception confirmation, notifying the sender terminal, by the server, of successful delivery via the communication network.

7. The parcel delivery method as claimed in claim 6, further comprising, between steps a) and b), the steps of:
i) upon receiving via the communication network from the sender terminal a loading request that includes loading geographic position information corresponding to a loading position where the parcel is to be loaded, transmitting, by the server, the loading geographic position information to the UAV via the communication network;
j) after receiving the loading geographic position information from the server terminal, determining, by the UAV based at least on the loading geographic position information, a pick-up flight path to the loading position so as to fly along the pick-up flight path to the loading position; and
k) after the parcel has been loaded on the UAV, transmitting, by the sender terminal, the delivery request to the server via the communication network.

8. The parcel delivery method as claimed in claim 7, wherein, in step j), the UAV determines the pick-up flight path based on the loading geographic position information and further on an environment map that covers the current position of the UAV and the loading position.

9. The parcel delivery method as claimed in claim 7, wherein the loading position is a position where the sender terminal is located.

10. The parcel delivery method as claimed in claim 1, the parcel delivery system including a plurality of recipient terminals, wherein a new recipient terminal can be added to the parcel delivery system by downloading a software from the server to the new recipient terminal to be registered in a group database of the server.

11. The parcel delivery method as claimed in claim 10, wherein the server transmits a copy of the group database to the recipient terminals whenever the group database is changed.

12. The parcel delivery method as claimed in claim 11, wherein the group database is shown on a graphical user interface on the recipient terminal through the execution of an app installed on the recipient terminal.

13. A parcel delivery method to be implemented by a parcel delivery system, the parcel delivery system including a sender terminal, a server, an unmanned aerial vehicle (UAV) and a recipient terminal that are connected to a communication network, the sender terminal being associated with and carried by a sender, the recipient terminal being associated with and carried by a recipient, said parcel delivery method comprising the steps of:
a) continuously receiving, by the server, recipient geographic position information from the recipient terminal and UAV geographic position information from the UAV via the communication network;
b) after receiving via the communication network from the sender terminal a delivery request for a parcel, which has been previously loaded on the UAV and is to be delivered to the recipient, transmitting, by the server, a delivery flight path, which has been previously determined based on the recipient geographic position information and the UAV geographic position information that are last received by the server and that cooperatively serve as destination information, to the UAV via the communication network; and
c) after receiving the delivery flight path from the server, transporting, by the UAV based the delivery flight path, the parcel to an unloading position where the recipient terminal is located.

14. The parcel delivery method as claimed in claim 13, further comprising, between steps a) and b), the step of:
d) determining, by the server, the delivery flight path based on the destination information.

15. The parcel delivery method as claimed in claim 13, further comprising, between steps a) and b), the steps of:
e) after receiving the delivery request, transmitting, by the server, the destination information to the sender terminal via the communication network;
f) upon receiving the destination information from the server, determining, by the sender terminal, the delivery flight path based on the destination information; and
g) transmitting, by the sender terminal, the delivery flight path to the server via the communication network in response to receipt of the destination information from the server.

16. A parcel delivery system comprising:
a server connected to a communication network;
an unmanned aerial vehicle (UAV) connected to the communication network, said UAV being configured to continuously generate UAV geographic position information thereof and to transmit the UAV geographic position information generated thereby to said server via the communication network; and
a recipient terminal associated with and carried by a recipient, and connected to the communication network, said recipient terminal storing an application associated with parcel delivery, continuously generating recipient geographic position information thereof, and transmitting, through execution of said application, the recipient geographic position information generated thereby to said server via the communication network;
wherein, after a parcel, which is to be delivered to the recipient, has been loaded on said UAV, said parcel delivery system is operable to perform a parcel-delivering procedure of a parcel delivery method, in the parcel-delivering procedure,
after receipt of a delivery request for the parcel via the communication network, said server transmits, through execution of said application, the recipient geographic position information, which is last received by said server and which serves as destination information, to said UAV via the communication network, and
after receipt of the destination information from said server, said UAV transports, based at least on the destination information, the parcel to an unloading position where said recipient terminal is located.

17. The parcel delivery system as claimed in claim 16, wherein, in response to receipt of the destination information from said server, said UAV further determines a delivery flight path to the unloading position based at least on the destination information such that said UAV transports the parcel to the unloading position based at least on the delivery flight path.

18. The parcel delivery system as claimed in claim 17, wherein said UAV determines the delivery flight path based on the destination information and further on an environment map that covers a current position of said UAV and the unloading position.

19. The parcel delivery system as claimed in claim 17, wherein:
said server further detects, based on the destination information and on the recipient geographic position information received thereby after the transmission of the destination information, whether the position of said recipient terminal has changed so as to generate a detection result, and transmits the detection result to said UAV via the communication network; and
said UAV transports the parcel to the unloading position based on the delivery flight path and further on the detection result from said server.

20. The parcel delivery system as claimed in claim 19, wherein:
when said server detects that the position of said recipient terminal has changed, the detection result includes updated destination information corresponding to the position of said recipient terminal that has changed; and
said UAV updates the delivery flight path based on the updated destination information, and transports the parcel to the unloading position along the delivery flight path updated thereby.

21. The parcel delivery system as claimed in claim 16, further comprising a sender terminal connected to the communication network, and associated with and carried by a sender, and wherein:
upon arrival at the unloading position, said UAV notifies said server of delivery completion via the communication network;
after unloading of the parcel from said UAV, said recipient terminal notifies, through execution of said application, said server of reception confirmation via the communication network; and
after receipt of the notifications of delivery completion and reception confirmation, said server notifies said sender terminal of successful delivery via the communication network.

22. The parcel delivery system as claimed in claim 21, wherein:
said sender terminal further stores said application; and
prior to operation of the delivering mode, said parcel delivery system is further operable to perform a parcel-loading procedure of the parcel delivery method, in the parcel-loading procedure,
said sender terminal transmits, through execution of said application, a loading request for the parcel to said server terminal via the communication network, the loading request including loading geographic position information corresponding to a loading position where the parcel is to be loaded,
upon receipt of the loading request from said sender terminal, said server transmits the loading geographic position information included in the loading request to said UAV via the communication network,
after receipt of the loading position information from said server, said UAV determines, based at least on the loading geographic position information, a return flight path to the loading position so as to fly along the return flight path to the loading position, and
after the parcel has been loaded on said UAV, said sender terminal generates the delivery request and transmits the delivery request to said UAV via the communication network through execution of said application.

23. The parcel delivery system as claimed in claim 22, wherein said UAV determines the return flight path based on the loading position information and further on an environment map that covers a current position of said UAV and the loading position.

24. The parcel delivery system as claimed in claim 22, wherein the loading position is a position where the sender terminal is located.

25. The parcel delivery system as claimed in claim 22, wherein:
said sender terminal further generates, through execution of said application, a user input interface that is displayed thereon and that provides a recipient list for recording the recipient; and
the recipient data is generated by said sender terminal through input operation of said user input interface.

26. The parcel delivery system as claimed in claim 25, wherein the recipient data includes a recipient list in which the recipient is recorded.

27. The parcel delivery system as claimed in claim 21, wherein each of said sender terminal and said recipient terminal is one of a smart phone, a tablet computer and a notebook computer.

28. The parcel delivery system as claimed in claim 16, wherein the communication network is a cellular network using 4G LTE technology.

29. A parcel delivery system comprising:
a sender terminal associated with and carried by a sender, and connected to a communication network, said sender terminal storing an application associated with parcel delivery;
a server connected to the communication network;
an unmanned aerial vehicle (UAV) connected to the communication network, said UAV being configured to continuously generate UAV geographic position information thereof and transmit the UAV geographic position information generated thereby to said server via the communication network; and
a recipient terminal associated with and carried by a recipient, and connected to the communication network, said recipient terminal storing the application, continuously generating recipient geographic position information thereof, and transmitting, through execution of said application, the recipient geographic position information generated thereby to said server via the communication network;
wherein, after loading of a parcel, which is to be delivered to the recipient, on said UAV, said parcel delivery system is operable to perform a parcel-delivering procedure of a parcel delivery method, in the parcel-delivering procedure,
after receiving from said sender terminal a delivery request for the parcel via the communication network, said server transmits a delivery flight path, which has been previously determined based on the recipient geographic position information and the UAV geographic position information that are last received by said server and that cooperatively serve as destination information, to said UAV via the communication network, and
after receipt of the delivery flight path from said server, said UAV transports, based on the delivery flight path, the parcel to an unloading position where said recipient terminal is located.

30. The parcel delivery system as claimed in claim 29, wherein said server terminal determines the delivery flight path based on the destination information.

31. The parcel delivery system as claimed in claim 29, wherein:
after the receipt of the delivery request, said server transmits the destination information to said sender terminal via the communication network; and
upon receipt of the destination information from said server, said sender terminal determines the delivery flight path based on the destination information, and transmits the delivery flight path determined thereby to said server via the communication network.
